(19) United States
(12) Patent Application Publication
(10) Pub. No.: US 2009/0106331 A1
(43) Pub. Date: Apr. 23, 2009

(54) DYNAMIC TWO-STAGE CLINICAL DATA ARCHIVING AND RETRIEVAL SOLUTION

(75) Inventors: Dmitriy Fridman, Geneva, IL (US); Anthony Ricamato, West Chicago, IL (US); Basel Hasan Taha, Arlington Heights, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/876,553

(22) Filed: Oct. 22, 2007

(51) Int. Cl. G06F 12/16

(52) U.S. Cl. 707/204

(57) ABSTRACT

Certain embodiments of the present invention provide methods and systems for dynamic, two-stage archiving and/or retrieval of clinical data. Certain embodiments provide a method for dynamic, two-stage clinical data archiving. The method includes copying clinical data from a primary datastore to a staging datastore, wherein non-clinical data is retained at the primary datastore and not passed to the staging datastore. The method further includes copying the clinical data from the staging datastore to an archive datastore. The method also includes deleting the clinical data from the staging datastore after the clinical data has been copied to the archive datastore. In certain embodiments, data may be restored from the archive datastore to the primary datastore via the staging datastore similar to the archiving process described above.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to archiving and retrieval of clinical data. More particularly, the present invention relates to methods and systems providing dynamic, two-stage archiving and retrieval of clinical data.

Current healthcare practice involves electronic data and records management. Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access patient information or other information at various points in a healthcare workflow. For example, during an imaging scan of a patient, medical personnel may access patient information, such as a patient exam order, that are stored in a medical information system. Alternatively, medical personnel may enter new information, such as history, diagnostic, and/or treatment information, into a medical information system during an imaging scan.

With the drive towards integrated Electronic Health Records (EHRs) and an explosion in the volume of clinical information being served from a single data store, the field of Clinical Information Systems (CISs) is witnessing very rapid clinical data growth. This raises many potential problems within an enterprise database environment. As clinical databases grow exponentially, application performance deteriorates proportionally, bottlenecks occur, and backup and upgrade times lengthen (see FIG. 1). Furthermore, government regulations dictate that patient data be readily accessible for extended periods (e.g., up to 26 years in some applications).

### BRIEF SUMMARY OF THE INVENTION

Certain embodiments of the present invention provide methods and systems for dynamic, two-stage archiving and/or retrieval of clinical data.

Certain embodiments provide a method for dynamic, two-stage clinical data archiving. The method includes copying clinical data from a primary datastore to a staging datastore, wherein non-clinical data is retained at the primary datastore and not passed to the staging datastore. The method further includes copying the clinical data from the staging datastore to an archive datastore. The method also includes deleting the clinical data from the staging datastore after the clinical data has been copied to the archive datastore.

In certain embodiments, data may be restored from the archive datastore to the primary datastore via the staging datastore similar to the archiving process described above.

Certain embodiments provide a dynamic, two-stage clinical data archiving and restoration system. The system includes a primary datastore storing clinical data, demographic data and application-specific data for a patient. The system also includes an archive datastore archiving clinical data from the primary datastore for later retrieval. Further, the system includes a staging datastore storing and relaying clinical data between the primary datastore and the archive datastore. The staging datastore retains the clinical data until at least one of an archive operation and a restore operation is complete between the primary datastore and the archive datastore. Additionally, the system includes a processor operating in conjunction with the primary datastore, the staging datastore, and the archive datastore. The processor is adapted to archive clinical data by copying clinical data from the primary datastore to the staging datastore, wherein non-clinical data is retained at the primary datastore and not passed to the staging datastore; copying the clinical data from the staging datastore to the archive datastore; and deleting the clinical data from the staging datastore after the clinical data has been copied to the archive datastore.

Certain embodiments provide a computer readable medium having a set of instructions for execution on a computer. The set of instructions includes an archive routine controlling a primary datastore, a staging datastore, and an archive datastore. The archive routine: a) copies clinical data from the primary datastore to the staging datastore, wherein non-clinical data is retained at the primary datastore and not passed to the staging datastore, b) copies the clinical data from the staging datastore to an archive datastore, and c) deletes the clinical data from the staging datastore after the clinical data has been copied to the archive datastore. The set of instructions also includes a restore routine controlling the primary datastore, the staging datastore, and the archive datastore. The restore routine: a) identifies clinical data to be restored from the archive datastore, b) copies the identified clinical data from the archive datastore to the staging datastore, c) copies the identified clinical data from the staging datastore to the primary datastore, and d) deletes the identified clinical data from the staging datastore.

### BRIEF DESCRIPTION OF SEVERAL VIEWS OF THE DRAWINGS

FIG. 1 illustrates a graph of application performance and database size over time.

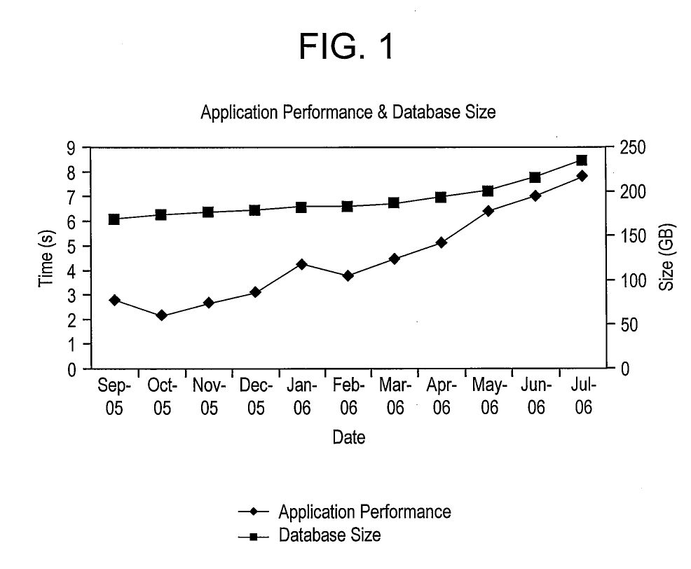

FIG. 2 illustrates a clinical data archiving and retrieval system used in accordance with an embodiment of the present invention.

FIG. 3 illustrates a data archive and retrieval flow in accordance with an embodiment of the present invention.

FIG. 4 depicts an exemplary patient census interface whereby a user may retrieve information for one or more listed patients.

FIG. 5 illustrates a flow diagram for a method for dynamic, two-stage clinical data archiving in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Mission critical, highly available Clinical Information Systems integrating data from multiple hospital departments place unique requirements on archival and retrieval systems and methods. Certain embodiments of the present invention describe archival and retrieval systems and methods that emphasize data integrity, recoverability, and seamless retrieval from within an application, and an ability to access certain high level patient attributes without restoring patient data.

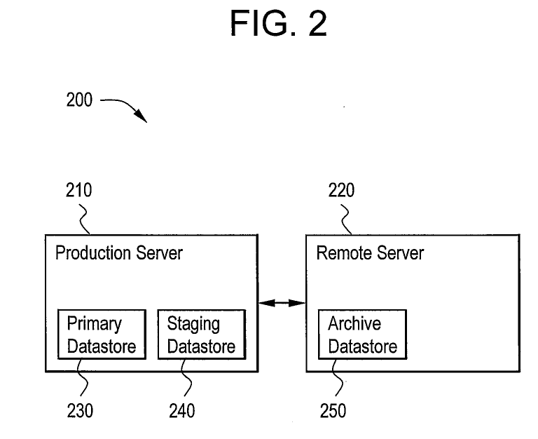

FIG. 2 illustrates a clinical data archiving and retrieval system 200 used in accordance with an embodiment of the present invention. The system 200 includes a production server 210 and a remote server 220. The production server 210 includes a primary datastore 230 and a staging datastore 240. The remote server 220 includes an archive datastore 250. The servers 210, 220 and datastores 230, 240, 250 may be implemented separately and/or in a variety of combinations. Additionally, each of the servers 210, 220 and datastores 230, 240, 250 may be implemented as single components and/or a plurality of connected components. For example, the archive datastore 250 may be implemented as a single storage medium and/or as a plurality of connected storage media. The servers 210, 220 and datastores 230, 240, 250 may be implemented in hardware, software, and/or firmware, for example.

The staging datastore 240 is used as an intermediary between the primary datastore 230 and the archive datastore 250. The staging datastore 240 is used to temporarily track, store, and relay data between the primary datastore 230 and the archive datastore 250 for data archiving and/or retrieval, for example.

One or more of the production server 210 and remote server 220 may include one or more workstations (not shown). In addition, while the primary datastore 230, staging datastore 240, and archive datastore 250 are shown in FIG. 2, the system 200 may include one or more additional data storage. Components of the system 200 can be located in a single physical location or in a plurality of locations. Components of the system 200 can be connected to and communicate via one or more networks.

Servers 210, 220 can be directly attached to and/or incorporate one or more datastores 230, 240, 250 and/or communicate with datastores 230, 240, 250 via one or more networks. Each server 210, 220 can be implemented using a specialized or general-purpose computer executing a computer program for carrying out the processes described herein. Servers 210, 220 and/or associated workstations can be personal computers or host attached terminals, for example. In certain embodiments, processing described herein can be shared by one or more servers 210, 220, datastores 230, 240, 250, and/or workstations by providing one or more applet(s) and/or other application/process sharing, for example.

Servers 210, 220 include one or more computer-readable storage media. For example, a storage medium can include a computer hard drive, a compact disc (“CD”) drive, a USB thumb drive, or any other type of memory capable of storing one or more computer software applications and/or electronic data. A storage medium can be included in servers 210, 220 and/or physically remote from servers 210, 220. For example, a storage medium can be accessible by servers 210, 220 through a wired or wireless network connection. A storage medium may include and/or be in addition to the primary, staging, and archive datastores 230, 240, 250.

A storage medium includes data and/or one or more sets of instructions for a computer (described in more detail below). A set of instructions includes one or more routines capable of being run or performed by server 210, 220 and/or associated processor(s), for example. The set of instructions can be embodied in one or more software applications or in computer code. Data storage can be implemented using a variety of devices for storing electronic information such as a file transfer protocol (“FTP”) server, for example. Data storage includes electronic data. For example, data storage can store EMRs for a plurality of patients.

Communication between components of the system 200 can occur via any one or more types of known networks including a local area network (“LAN”), a wide area network (“WAN”), an intranet, or a global network (for example, Internet). Any two components of the system 200 can be coupled to one another through multiple networks (for example, intranet and Internet) so that not all components of system 200 are required to be coupled to one another through the same network.

Components of the system 200 can be connected to a network and/or one another in a wired or wireless fashion. In an example embodiment, the production server 210 and the remote server 220 communicate via the Internet. In another embodiment, servers 210 and 220 communicate via a dedicated or virtual private network, for example.

One or more of the primary, staging, and archive datastores 230, 240, 250 can be implemented as a storage medium and/or portion of a storage medium accessible by a processor in the production server 210 and/or remote server 220 and/or a separate processor associated with the datastore 230, 240, and/or 250, for example. In certain embodiments, a datastore 230, 240, and/or 250 can operate as a network server (often referred to as a web server) to communicate with server 210 and/or 220. In certain embodiments, datastore 230, 240, 250 can also include a firewall to prevent unauthorized access and enforce any limitations on authorized access. The firewall can be implemented using conventional hardware, firmware, and/or software, for example.

In certain embodiments, a datastore 230, 240, 250, alone or in conjunction with production server 210 and/or remote server 220 can execute one or more application programs to provide access to data stored on datastore 230, 240, 250. In certain embodiments, a datastore 230, 240, 250 can also operate as a database server and coordinate access to application data including data stored on the datastore, for example.

In certain embodiments, datastore 230, 240, 250 are configured to store data that is recorded with or associated with a time and/or date stamp. For example, a data entry can be stored in datastore 230, 240, 250 along with a time and/or date at which the data was entered or recorded initially or at datastore 230, 240, 250. The time/date information can be recorded along with the data as, for example, metadata. Alternatively, the time/date information can be recorded in the data in manner similar to the remainder of the data. In another alternative, the time/date information can be stored in a relational database or table and associated with the data via the database or table.

In an embodiment, datastore 230, 240, 250 is configured to store medical data for a patient in a flowsheet, patient chart, and/or other record format. The medical data can include data such as numbers and text. The medical data can also include information describing medical events. For example, the medical data/events can include a name of a medical test performed on a patient. The medical data/events can also include the result(s) of a medical test performed on a patient. For example, the actual numerical result of a medical test can be stored as a result of a medical test. In another example, the result of a medical test can include a finding or analysis by a caregiver that entered as text.

In another example, the medical data/events can include the name and/or results of an imaging procedure. Such imaging procedures include, but are not limited to, CT scans, MRI scans, photographs, tomographic images, and computer models, for example.

The medical data/events can also include a description of a medical visit. For example, the medical data/event can list the date and/or time of a visit to a hospital, doctor's office or clinic, as well as details about what tests, procedures or examinations were performed during the visit. In addition, the data/event can include results of the tests, procedures and examinations as described above. The data/event can include the names of all caregivers that came into contact or provided medical care to the patient during the visit. The data/event can also include information on the length of the visit, as well as any symptoms complained of by a patient and/or noted by a caregiver or other staff.

In another example, the medical data/events can include a description of a medical problem that a patient is experiencing. For example, an injury can be recorded as a medical problem, as well as any illnesses (chronic or otherwise) a patient is experiencing.

The medical data/events can also include details of a caregiver encounter. For example, the data/event can include information such as the date/time of an encounter with a doctor, nurse or other caregiver (such as a radiologist, for example). The data/event can include additional information such as what medical tests, examinations or procedures were performed on a patient by a specific caregiver. For example, if nurse “X” takes a blood sample from a patient, records the weight of a patient and tests the patient's blood pressure, then all of these tests and procedures, as well as the results, can be recorded as medical data/events associated with nurse X.

In another example, medical data/events can include a description and/or results of a medical procedure. For example, the name and outcome of a surgery or outpatient procedure can be recorded as a medical procedure.

Medical data/events can also include a description of any symptoms experienced by a patient. This information can be recorded as text or by a codification scheme. For example, medical data/events can include descriptions such as a headache, chest pains or dizziness.

The medical data/events stored in a patient flowsheet can also include any biological analyses performed on the patient. For example, the data/events can include the numerical results of blood, enzyme or other fluid tests. In another example, the data/events can include a text description of the results of a biological analysis.

In another example, the medical data/events can include a finding by a caregiver. A finding can include any numeric and/or text-based description of a discovery or analysis made by the caregiver. For example, a radiologist can analyze a series of x-ray images of a patient and find a growth or tumor in the patient. The radiologist can then record his or her finding in a patient flowsheet or record.

The medical data/events can also include one or more medications a patient is or has taken. The data can include the date, time, dosage and/or name of medication, for example.

The medical data/events can also include one or more acquisitions. An acquisition can include any actual data acquired and/or the date at which the data is acquired. For example, an acquisition can include the results and/or date/time at which results from a laboratory test were acquired.

While the above provides several examples of the types of medical data/events that can be used in accordance with embodiments of the presently described technology, it is to be understood that the presently described technology is not limited to the above data/events. In addition, while some types of information stored as medical data/events described above is repeated, it is to be understood that various medical data/events can be stored multiple times. For example, if a patient complains of a symptom to a caregiver during a particular office visit, the symptom can be recorded by itself and/or with additional information, such as the name of the caregiver and any procedures performed on the patient.

In an embodiment, the medical data/events include the actual information desired to be stored. Alternatively, the medical data/events can include a code representative of the actual information desired to be stored. For example, the codes provided by the International Statistical Classification of Diseases and Related Health Problems (“ICD”) can be stored in place of the actual information related to the medical data/event.

Patient data stored in datastore 230, 240, 250 may include patient identifying information and/or may be separated from and/or otherwise stripped of patient identifying information, for example.

In operation, data is archived automatically and/or upon user initiation from the primary datastore 230 on the production server 210 to the archive datastore 250 on the remote server 220 via the staging datastore 240. For example, a flowsheet and/or other patient data entry/viewing application may be configured for a periodic, scheduled archiving of data to an archive 250. As another example, a user viewing and/or editing clinical data at the production server 210 and/or a workstation connected to the server 210 may manually initiate archiving of some or all of the clinical data to the archive datastore 250.

Data identified for archiving is copied from storage at the primary datastore 230 (the source) to the staging datastore 240. As data arrives at the staging datastore 240 it is relayed to the archive datastore 250. For example, data may be copied from the staging datastore 240 to the archive datastore 250 on a rolling basis as the data is received. As another example, data may be copied from the staging datastore 240 to the archive datastore 250 as copying of blocks or chunks of data (e.g., a portion or all of a data file or patient record) is completed at the staging datastore 240. Once data is archived at the archive datastore 250, data may be deleted from the staging datastore 240 and the primary datastore 230. If data archiving is interrupted, data and state information exist at the primary datastore 230 and/or staging datastore 240 to resume archiving of the data to the archive datastore 250 after the interruption has been removed (e.g., automatically and/or manually), for example.

For data retrieval, the process described above is reversed. For example, data may be archived at the archive datastore 250 according to a medical record number and/or other alphanumeric identifier. Identified data is copied from the archive datastore 250 at the remote server 220 to the staging datastore 240 at the production server 210. Data is then copied from the staging datastore 240 to the primary datastore 230 for use at the production server 210 and/or a connected workstation. For example, data may be copied from the staging datastore 240 to the primary datastore 230 on a rolling basis as the data is received from the archive datastore 250. As another example, data may be copied from the staging datastore 240 to the primary datastore 230 as copying of blocks or chunks of data (e.g., a portion or all of a data file or patient record) is completed at the staging datastore 240.

Once data is restored at the primary datastore 230, data may be deleted from the staging datastore 240 and the archive datastore 250. If data restoration is interrupted, data and state information exist at the archive datastore 250 and/or staging datastore 240 to resume restoration of the data to the primary datastore 230 after the interruption has been removed (e.g., automatically and/or manually), for example.

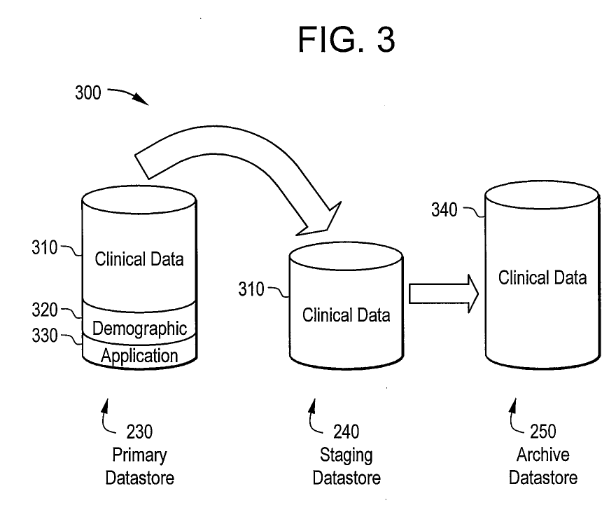

In certain embodiments, as illustrated in FIG. 3, only a portion of patient data at the primary datastore 230 is archived at the archive datastore 250. As shown in the data archive and retrieval flow 300, data at the primary datastore 230 includes clinical data 310, patient demographic data 320, and application data 330. As shown in FIG. 3, only clinical data 310 is transferred to the staging datastore 240 for archiving with other clinical data 340 at the archive datastore 250. Demographic 320 and application-specific information 330 may be left on the primary datastore 230 for later use and/or discarding, for example. In certain embodiments, demographic 320 and/or application-specific information 330 on the primary datastore 230 may be used to facilitate access to corresponding clinical data 310 stored with other clinical data 340 at the archive datastore 250. In certain embodiments, removing demographic 320 and/or application-specific data 330 from the clinical data 310 may allow the clinical data 310 to be used in anonymous clinical studies, reports, and the like. Removal of demographic 320 and/or application-specific data 330 may also allow the clinical data 310 to be used in a variety of applications, for example.

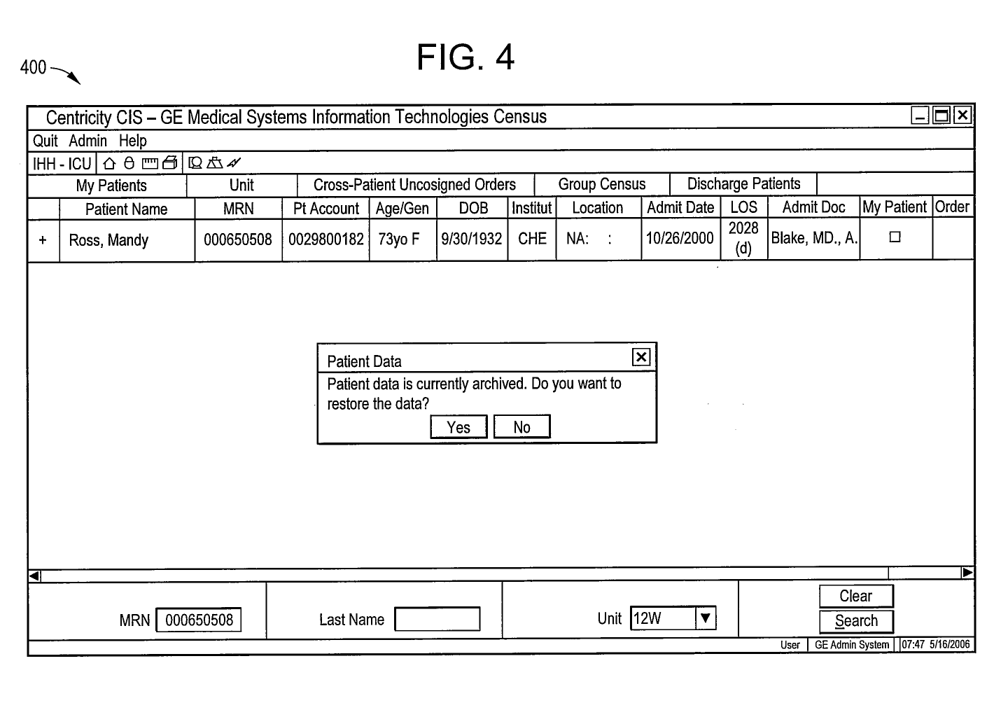

Data may be restored from the archive datastore 250 automatically and/or upon specific user request, for example. As shown in FIG. 4, data may be accessed by a user via a patient viewing interface or application, such as a patient list, patient chart, census, etc. FIG. 4 depicts an exemplary patient census interface 400 whereby a user may retrieve information for one or more listed patients. If information for a selected patient includes archived data, the archived data may be automatically restored to the primary datastore 230 via the staging datastore 240 for use by the user. Alternatively, as shown in FIG. 4, the application may notify the user that the requested data is archived and prompt the user for approval to restore the data.

In certain embodiments, data archived at the archive data store 250 is compressed upon receipt from the staging datastore 240. Similarly, if data is compressed at the archive datastore 250, the data is then uncompressed when being restored or copied to the primary datastore 230 via the staging datastore 240.

In certain embodiments, data from a plurality of primary datastores 230 at one or more production servers 210 can be archived at one or more archive datastores 250 via one or more staging datastores 240. In certain embodiments, archived data at the archive datastore 250 may be restored to one or more of a plurality of primary datastores 230 regardless of whether the data was archived from the destination primary datastore(s) 230.

In certain embodiments, the remote server 220 and archive datastore 250 provide an ability to search the archive data from within an application without requiring a restore of the data to the primary datastore 230.

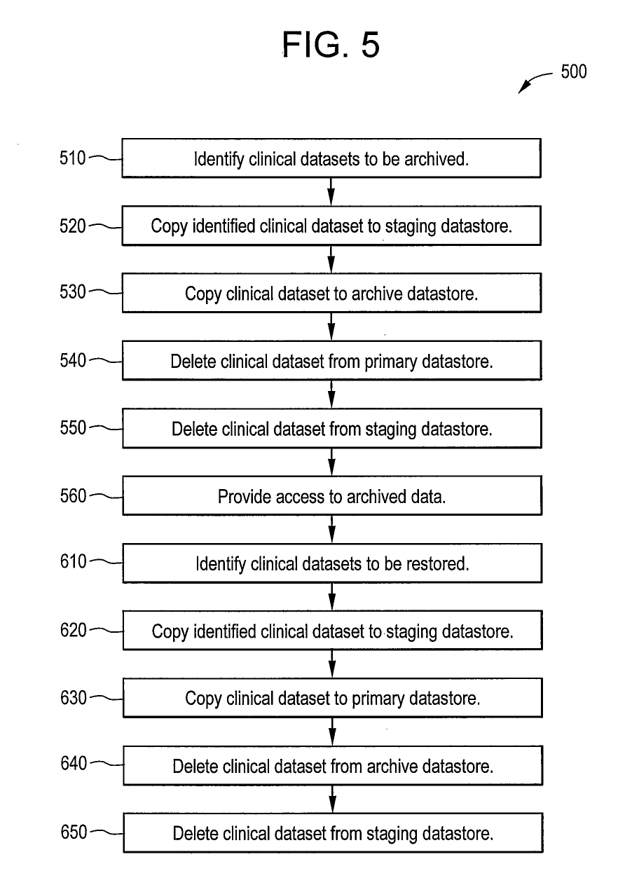

FIG. 5 illustrates a flow diagram for a method 500 for dynamic, two-stage clinical data archiving in accordance with an embodiment of the present invention. At step 510, clinical datasets to be archived are identified. In a clinical context, patient datasets to be archived may be based on several possible criteria determining the “currency” of the retained dataset. For example, all datasets from patients that have a discharge date greater than two years from current date may be automatically archived.

At step 520, the clinical dataset identified in step 510 is copied from the primary datastore into a staging datastore. In certain embodiments, at step 520, the patient identifying data is retained in the primary datastore. In certain embodiments, application-specific information is retained in the primary datastore.

At step 530, the clinical dataset is copied from the staging datastore into the archive datastore. At step 540, the clinical dataset is deleted from primary datastore. At step 550, the clinical dataset is deleted from staging datastore.

At step 560, access to the archived data is provided via the application. From the application's master patient list the user has the ability to retrieve an archived patient's dataset as required by workflow.

Data may also be retrieved from an archive. At step 610, one or more datasets to be restored from the archive are identified. One or more datasets to be restored may be identified automatically and/or manually via a data access application, for example. In certain embodiments, a user may not be aware that a record being requested is archived. That is, data retrieval in whole or in part from an archive may be transparent to the user because the particular application is aware of whether the requested data is available via the primary datastore and/or the archive datastore, for example. In certain embodiments, a patient dataset to be restored is identified by medical record number, for example.

At step 620, a dataset identified at step 610 is copied from the archive datastore into the staging datastore.

At step 630, the dataset is copied from the staging datastore into the primary datastore.

At step 640, the dataset is deleted from the archive datastore. At step 650, the dataset is deleted from staging datastore.

In certain embodiments, use of a staging datastore in an archiving and retrieval process allows for an archive datastore to be located on a remote server. Locating an archive datastore on a remote server helps to reduce or minimize storage requirements on a production server. Locating an archive datastore on a remote server helps to reduce or minimize other resource requirements/utilization on the production server (e.g., memory, processor, etc.). Locating an archive datastore on a remote server helps to reduce or minimize resource contention (i.e. table locking) since only one large datastore is being accessed at a time (e.g., primary datastore/staging datastore as opposed to primary datastore/archive datastore).

In certain embodiments, in an event of a software and/or hardware failure during the archiving process, use of a staging datastore as an intermediary between the primary datastore and the archive datastore reduces or eliminates loss of data being archived. Using the primary and staging datastore, two copies of the dataset being archived may be retained until the archiving process completes successfully. Additionally, using a two stage system and process allows for automatic data recovery and for automatic resumption of the archiving/retrieval process after an interruption when the system is online and operational again.

Thus, certain embodiments provide a technical effect of automatic data recoverability through use of the staging datastore in case of software or hardware failure during an archiving and/or retrieval process. At any point in time, data is intact in either the original source (e.g., a primary datastore when archiving data or an archive datastore when restoring data) or two other sources (e.g., a destination or source datastore, and a staging datastore). Certain embodiments provide a technical effect of safeguarding mission and health critical information systems using data integrity and information lifecycle management.

In certain embodiments, reducing the amount of data in an application production database while still providing access to archived data allows adherence to regulatory guidelines and also maintains application performance at an acceptable level. In certain embodiments, database size may be reduced by not archiving demographic and application-specific information. Such reduction may lead to an increase in database performance due to decreased requirements for data throughput, etc. Similarly, decreased maintenance or backup time may result.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a PACS workstation or one or more dedicated processors.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

In certain embodiments, a set of instructions for executing the systems and methods described herein includes an archive routine controlling a primary datastore, a staging datastore, and an archive datastore. The archive routine: a) copies clinical data from the primary datastore to the staging datastore, wherein non-clinical data is retained at the primary datastore and not passed to the staging datastore, b) copies the clinical data from the staging datastore to an archive datastore, and c) deletes the clinical data from the staging datastore after the clinical data has been copied to the archive datastore. The set of instructions also includes a restore routine controlling the primary datastore, the staging datastore, and the archive datastore. The restore routine: a) identifies clinical data to be restored from the archive datastore, b) copies the identified clinical data from the archive datastore to the staging datastore, c) copies the identified clinical data from the staging datastore to the primary datastore, and d) deletes the identified clinical data from the staging datastore.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any healthcare information system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A method for dynamic, two-stage clinical data archiving, said method comprising:
copying clinical data from a primary datastore to a staging datastore, wherein non-clinical data is retained at the primary datastore and not passed to the staging datastore;
copying the clinical data from the staging datastore to an archive datastore; and
deleting the clinical data from the staging datastore after the clinical data has been copied to the archive datastore.

2. The method of claim 1, further comprising deleting the clinical data from the primary datastore after the clinical data has been copied to the archive datastore.

3. The method of claim 1, further comprising identifying the clinical data to be archived based on one or more criteria.

4. The method of claim 1, wherein the primary datastore and the staging datastore are provided by a production server and the archive datastore is provided by a remote server.

5. The method of claim 1, further comprising automatically resuming copying of the clinical data to the archive datastore following an interruption of the archiving process.

6. The method of claim 1, further comprising searching clinical data stored at the archive datastore without restoring the clinical data to the primary datastore.

7. The method of claim 1, further comprising providing access by a user to archived data at the archive datastore.

8. The method of claim 7, wherein the step of providing access to the archived data further comprises facilitating retrieval of an archived patient dataset via a patient list.

9. The method of claim 1, further comprising:
identifying clinical data to be restored from the archive datastore;
copying the identified clinical data from the archive datastore to the staging datastore;
copying the identified clinical data from the staging datastore to the primary datastore; and
deleting the identified clinical data from the staging datastore.

10. The method of claim 9, further comprising deleting the identified clinical data from the archive datastore.

11. The method of claim 9, wherein said identifying step further comprises identifying clinical data to be restored from the archive datastore based on a medical record number.

12. A dynamic, two-stage clinical data archiving and restoration system, said system comprising:
a primary datastore storing clinical data, demographic data and application-specific data for a patient;
an archive datastore archiving clinical data from the primary datastore for later retrieval;
a staging datastore storing and relaying clinical data between the primary datastore and the archive datastore, the staging datastore retaining the clinical data until at least one of an archive operation and a restore operation is complete between the primary datastore and the archive datastore; and
a processor operating in conjunction with the primary datastore, the staging datastore, and the archive datastore, the processor adapted to archive clinical data by:
copying clinical data from the primary datastore to the staging datastore, wherein non-clinical data is retained at the primary datastore and not passed to the staging datastore;
copying the clinical data from the staging datastore to the archive datastore; and
deleting the clinical data from the staging datastore after the clinical data has been copied to the archive datastore.

13. The system of claim 12, wherein the primary datastore and the staging datastore reside on a production server and the archive datastore resides on a remote server.

14. The system of claim 12, wherein the processor is further adapted to restore clinical data comprising:
identifying clinical data to be restored from the archive datastore;
copying the identified clinical data from the archive datastore to the staging datastore;
copying the identified clinical data from the staging datastore to the primary datastore; and
deleting the identified clinical data from the staging datastore.

15. The system of claim 12, wherein the processor automatically resumes copying of the clinical data to the archive datastore following an interruption of the archiving process.

16. The system of claim 12, wherein the processor facilitates searching of clinical data stored at the archive datastore without restoring the clinical data to the primary datastore.

17. The system of claim 12, wherein the processor provides access by a user to archived data at the archive datastore.

18. The system of claim 17, wherein the processor provides access to the archived data by facilitating retrieval of an archived patient dataset via a patient list.

19. The system of claim 12, further comprising a graphical user interface allowing a user to execute the functions of the processor.

20. A computer readable medium having a set of instructions for execution on a computer, said set of instructions comprising:
an archive routine controlling a primary datastore, a staging datastore, and an archive datastore, wherein the archive routine:
a) copies clinical data from the primary datastore to the staging datastore, wherein non-clinical data is retained at the primary datastore and not passed to the staging datastore,
b) copies the clinical data from the staging datastore to an archive datastore, and
c) deletes the clinical data from the staging datastore after the clinical data has been copied to the archive datastore; and
a restore routine controlling the primary datastore, the staging datastore, and the archive datastore, wherein the restore routine:
a) identifies clinical data to be restored from the archive datastore,
b) copies the identified clinical data from the archive datastore to the staging datastore,
c) copies the identified clinical data from the staging datastore to the primary datastore, and
d) deletes the identified clinical data from the staging datastore.
